(19) United States
(12) Patent Application Publication
(10) Pub. No.: US 2022/0325946 A1
(43) Pub. Date: Oct. 13, 2022

(54) SELECTIVE IMAGE CAPTURE USING A PLURALITY OF CAMERAS IN A REFRIGERATOR APPLIANCE

(71) Applicant: Haier US Appliance Solutions, Inc., Wilmington, DE (US)

(72) Inventors: Michael Goodman Schroeder, Louisville, KY (US); Stephanos Kyriacou, Louisville, KY (US)

(21) Appl. No.: 17/227,447

(22) Filed: Apr. 12, 2021

(51) Int. Cl. F25D 29/00; H04N 5/247; H04N 7/18; G06K 9/00; G06N 3/08

(52) U.S. Cl. CPC F25D 29/005; H04N 5/247; H04N 7/188; H04N 7/181; G06K 9/00624; G06N 3/08; F25D 2700/06; F25D 2500/06; G06K 2209/17

(57) ABSTRACT

A refrigerator appliance is provided including a cabinet defining a chilled chamber, a door rotatably hinged to the cabinet to provide selective access to the chilled chamber, and a plurality of cameras mounted to the cabinet for monitoring the chilled chamber. A controller is configured to detect motion at one or more locations within the chilled chamber using image differentiation or motion sensors, identify a subset of cameras of the plurality of cameras based at least in part on the one or more locations where motion was detected, obtain one or more images using the subset of cameras, and analyze or transmit the one or more images for analysis.

### FIELD OF THE INVENTION

The present subject matter relates generally to refrigerator appliances, and more particularly to methods of operating a plurality of cameras in a refrigerator appliance.

### BACKGROUND OF THE INVENTION

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

Notably, it is frequently desirable to monitor food items in the refrigerator appliance, have knowledge of what food items are added to or removed from within the refrigerator appliance, and have other information related to the presence of food items. Certain conventional refrigerator appliances include a camera for monitoring food items as they are added or removed from the refrigerator appliance. However, a single camera is often not capable of detecting objects placed in all regions of the chilled chamber. As a result, it may be desirable to use multiple cameras, each camera being positioned to monitor a region of the chilled chamber. However, use of multiple cameras results in a large number of images that are costly to store, analyze, and/or transmit. As a result, these refrigerator appliances must include larger, more costly hardware and expend more power during operation.

Accordingly, a refrigerator appliance with systems for improved inventory management would be useful. More particularly, a refrigerator appliance that uses multiple cameras in an efficient manner to address some of the issues mentioned above would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a refrigerator appliance is provided including a cabinet defining a chilled chamber, a door being rotatably hinged to the cabinet to provide selective access to the chilled chamber, a plurality of cameras mounted to the cabinet for monitoring the chilled chamber, and a controller operably coupled to the plurality of cameras. The controller is configured to detect motion at one or more locations within the chilled chamber, identify a subset of cameras of the plurality of cameras based at least in part on the one or more locations where motion was detected, and obtain one or more images using the subset of cameras.

In another exemplary embodiment, a method of operating a refrigerator appliance is provided. The refrigerator appliance includes a chilled chamber and a plurality of cameras monitoring the chilled chamber. The method includes detecting motion at one or more locations within the chilled chamber, identifying a subset of cameras of the plurality of cameras based at least in part on the one or more locations where motion was detected, and obtaining one or more images using the subset of cameras.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1, with the doors of the fresh food chamber shown in an open position to reveal a camera assembly according to an exemplary embodiment of the present subject matter.

FIG. 3 provides a schematic view of a plurality of cameras monitoring a chilled chamber according to an exemplary embodiment of the present subject matter.

FIG. 4 provides a schematic view of a plurality of motion sensors and a plurality of cameras monitoring a chilled chamber according to an exemplary embodiment of the present subject matter.

FIG. 5 provides a method for operating a refrigerator appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

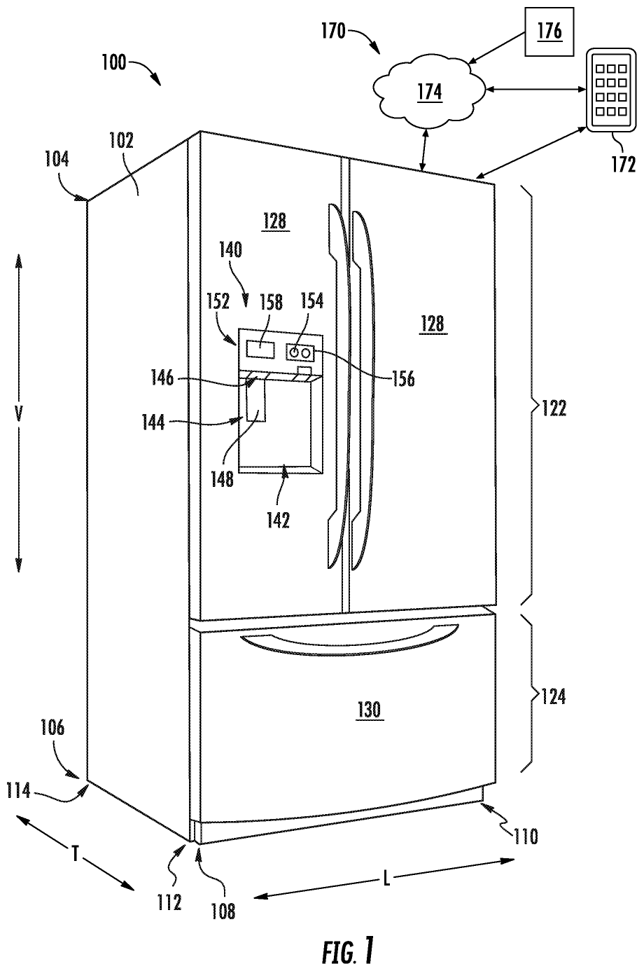

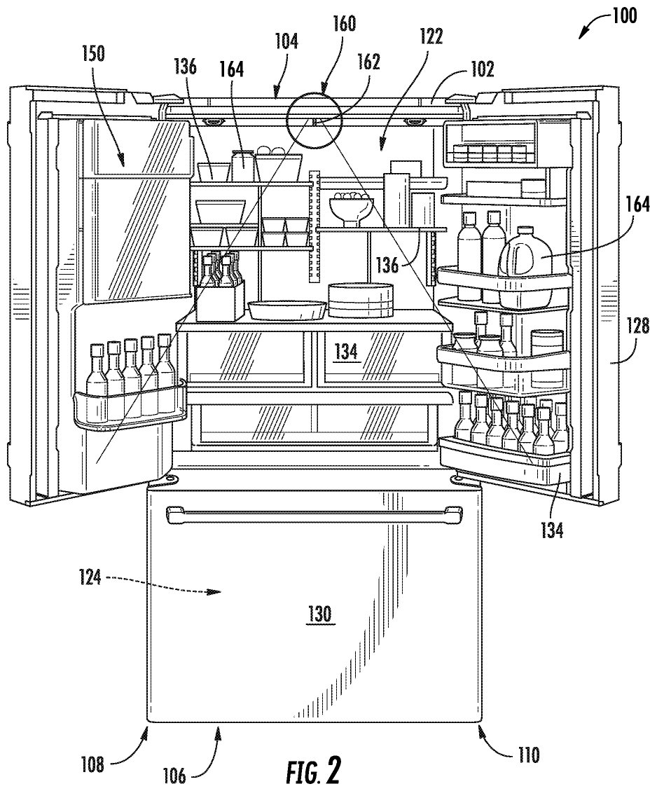

Referring now to the figures, an exemplary appliance will be described in accordance with exemplary aspects of the present subject matter. Specifically, FIG. 1 provides a perspective view of an exemplary refrigerator appliance 100 and FIG. 2 illustrates refrigerator appliance 100 with some of the doors in the open position. As illustrated, refrigerator appliance 100 generally defines a vertical direction V, a lateral direction L, and a transverse direction T, each of which is mutually perpendicular, such that an orthogonal coordinate system is generally defined.

According to exemplary embodiments, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 102.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1. One skilled in the art will appreciate that other chamber and door configurations are possible and within the scope of the present invention.

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring now generally to FIGS. 2 through 4, refrigerator appliance 100 may further include a camera assembly 160 that is generally positioned and configured for obtaining images of refrigerator appliance 100 during operation. Specifically, according to the illustrated embodiment, camera assembly 160 includes a plurality of cameras 162 that are mounted to cabinet 102, to doors 128, or are otherwise positioned in view of fresh food chamber 122. Although camera assembly 160 is described herein as being used to monitor fresh food chamber 122 of refrigerator appliance 100, it should be appreciated that aspects of the present subject matter may be used to monitor any other suitable regions of any other suitable appliance, e.g., such as freezer chamber 124.

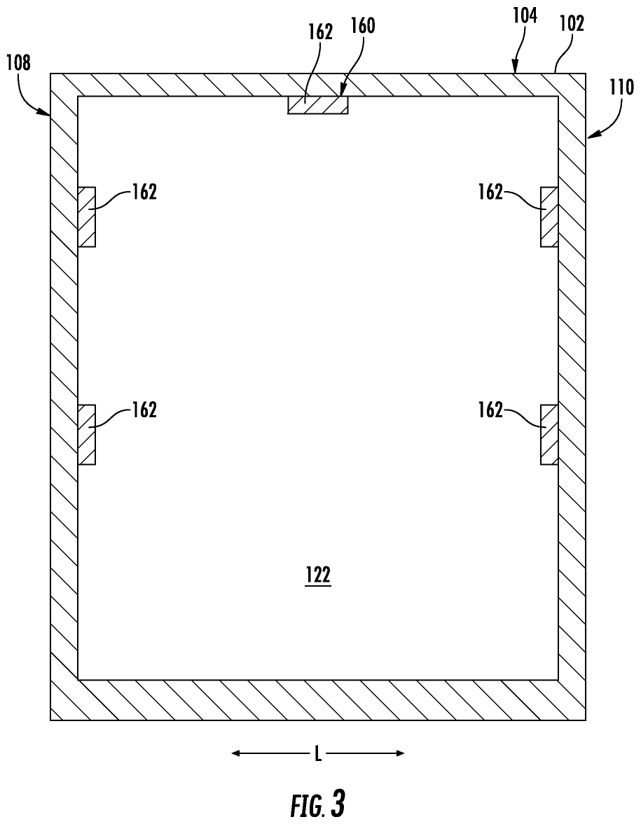

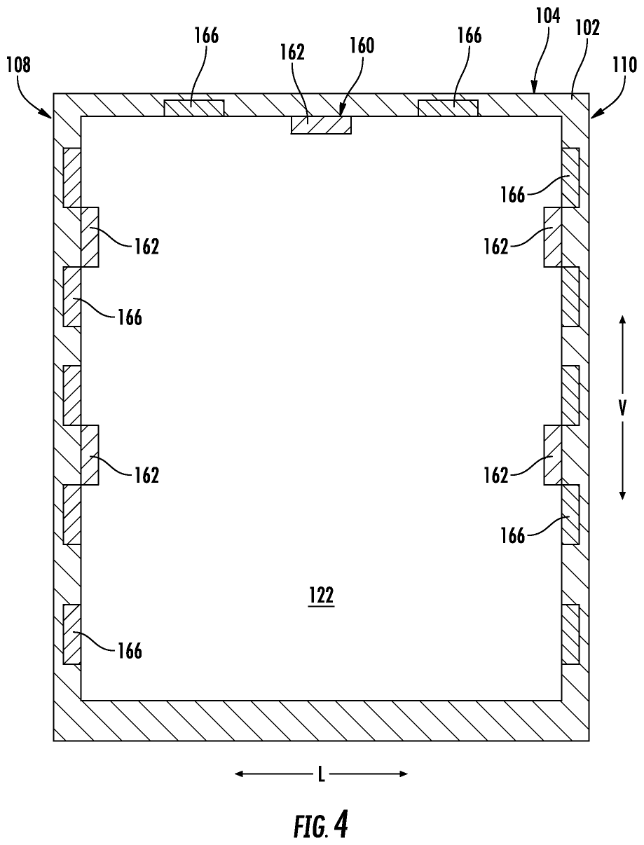

As best shown in FIGS. 3 and 4, the plurality of cameras 162 of camera assembly 160 are positioned around fresh food chamber 122 and are generally oriented toward a specific region or monitoring location. In this regard, for example, the field of view of each camera 162 may be limited to or focused on a specific area within fresh food chamber. Thus, depending on the location where a food item is being added or removed, a subset of cameras 162 of camera assembly 160 may preferably be used to obtain the most useful images. In this regard, the subset of cameras 162 may be one or more of the plurality of cameras 162 that have a desired field of view. As a result, multiple cameras 162 are spaced apart around a perimeter of fresh food chamber 122 and are oriented such that a complete representation of fresh food chamber 122 may be obtained and motion in any particular region may be monitored accurately. Specifically, according to exemplary embodiments, camera assembly 160 may be used to facilitate an inventory management process for refrigerator appliance 100. As such, each camera 162 may be positioned at an opening to fresh food chamber 122 to monitor food items (identified generally by reference numeral 164) that are being added to or removed from fresh food chamber 122.

According to the illustrated embodiment, cameras 162 are spaced apart along the vertical direction V and along the lateral direction L at desired intervals such that each camera 162 has a field of view in a certain region and the camera assembly 160 as a whole has a substantially complete view of fresh food chamber 122. In other words, the cameras 162 are positioned within cabinet 102 to define a virtual grid in a plane defined by the vertical direction V and the lateral direction L that corresponds with an opening of fresh food chamber 122. For example, camera assembly 160 may include a plurality of horizontal-mount cameras 162 positioned on a side of cabinet 102 at an opening of chilled chamber 122 and being oriented along a horizontal direction, e.g., along the lateral direction L. In addition, camera assembly 160 may include a plurality of vertical-mount cameras 162 positioned at a top of cabinet 102 at the opening of chilled chamber 122 and being oriented downward along a vertical direction V. Thus, camera assembly 160 is generally configured for monitoring an entrance to fresh food chamber 122, e.g., for monitoring food items 164 being added or removed from fresh food chamber 122, as described in more detail below.

According to still other embodiments, each camera 162 may be oriented in any other suitable manner for monitoring any other suitable region within or around refrigerator appliance 100. It should be appreciated that according to alternative embodiments, camera assembly 160 may include any suitable number, type, size, and configuration of camera(s) 162 for obtaining images of any suitable areas or regions within or around refrigerator appliance 100. In addition, it should be appreciated that each camera 162 may include features for adjusting the field-of-view and/or orientation. It should be appreciated that the images obtained by camera assembly 160 may vary in number, frequency, angle, resolution, detail, etc. in order to improve the clarity of the particular regions surrounding or within refrigerator appliance 100. In addition, according to exemplary embodiments, controller 156 may be configured for illuminating the chilled chamber using one or more light sources prior to obtaining images. Notably, controller 156 of refrigerator appliance 100 (or any other suitable dedicated controller) may be communicatively coupled to camera assembly 160 and may be programmed or configured for analyzing the images obtained by camera assembly 160, e.g., in order to identify items being added or removed from refrigerator appliance 100, as described in detail below.

According to the illustrated embodiment, each camera 162 may be positioned and oriented for monitoring a specific region of fresh food chamber 122. In this regard, for example, the bottom left camera 162 (as shown in FIG. 3) may be positioned for obtaining the best images of items positioned into a lower left corner of fresh food chamber 122. Similarly, the top middle camera 162 may be positioned for obtaining the best images of items positioned on the top middle shelf, and so on. Notably, constantly analyzing images obtained by all cameras 162 and all regions may be very computationally intensive, requiring more processing power and/or memory, e.g., at controller 156. In addition, if image data needs to be transmitted to a remote server for analysis, the costs of transmitting that data may increase proportionally with the data size. Moreover, using a particular camera to monitor regions that are distant from the camera or which have items blocking the field of view of the camera may result in a waste of computer resources and may introduce errors or inaccuracies into the image analysis. As a result, aspects of the present subject matter are directed to methods for obtaining, analyzing, and/or transmitting image data in a more intelligent manner to minimize computer resources and costs associated with data transmission.

Notably, according to exemplary embodiments of the present subject matter, data transmission and computer resources may be conserved by only operating those cameras 162 of camera assembly 160 that are detecting motion or moving objects, or which are otherwise in best view of such movements. As such, aspects of the present subject matter are directed to methods for detecting such motion and enabling/disabling cameras based on their proximity or field-of-view relative to the objects in motion. Although exemplary methods of detecting such motion and responsive actions are described herein, it should be appreciated that other methods for detecting motion and other responsive actions are possible and within the scope of the present subject matter.

According to exemplary embodiments one method of detecting motion may be implementing image analysis using sequentially obtained images, as will be described in more detail below. According to another exemplary embodiment, detecting such motion may rely on one or more motion sensors 166 that are positioned within or mounted to cabinet 102 for detecting such motion. According to exemplary embodiments, motion sensors 166 may be any suitable optical, acoustic, electromagnetic, or other sensors suitable for detecting motion within a space. For example, these motion sensors may include proximity sensors, time of flight sensors, infrared sensors, optical sensors, etc.

In general, each motion sensor 166 may establish a baseline for comparison, e.g., associated with a reading when no motion is detected. Thus the system of motion sensors 166 may form a grid or array from which motion may be detected. Each motion sensor 166 may be used to estimate the distance from the moving object or determine a proximity of that object to the camera 162. The object in motion may be virtualized into a two-dimensional position by analyzing and comparing feedback from some or all sensors 166. For example, if the top two sensors detect motion, then object is likely between those sensors 166 along the vertical direction V. It should be appreciated that weighted averaging may be used to obtain an accurate prediction of the location where motion is occurring. In addition, it should be appreciated that the sensor configuration and analysis methods are only exemplary and may vary while remaining within the scope of the present subject matter.

Referring now specifically to FIG. 4, an exemplary configuration of motion sensors 166 will be described. Specifically, as shown, the one or more motion sensors 166 may be spaced apart along the vertical direction V and the lateral direction L to define a location grid for detecting motion at one or more locations. In this regard, for example, motion sensors 166 may be spaced apart in a manner similar to cameras 162, e.g., along the sides and top of fresh food chamber 122. In this manner, controller 156 may determine the location or locations where motion is occurring based on feedback from motion sensors 166. For example, the vertical location of motion may be determined by motion sensors 166 mounted on the sidewalls of fresh food chamber 122, while the horizontal location of motion may be determined by motion sensors 166 mounted to the top wall of fresh food chamber 122. According to exemplary embodiments, controller 156 may activate only one camera 162 that is closest to the location of motion, or any other suitable configuration of cameras to best obtain an image or images of the region where motion is located. Although motion sensors 166 are illustrated herein as being interspaced or positioned between cameras 162, it should be appreciated that according to exemplary embodiments, each motion sensor 166 may be co-located with and/or associated with a specific camera 162 of camera assembly 160. Exemplary methods of using motion sensors 166 will be described below in more detail.

Referring still to FIG. 1, a schematic diagram of an external communication system 170 will be described according to an exemplary embodiment of the present subject matter. In general, external communication system 170 is configured for permitting interaction, data transfer, and other communications between refrigerator appliance 100 and one or more external devices. For example, this communication may be used to provide and receive operating parameters, user instructions or notifications, performance characteristics, user preferences, images obtained by camera assembly 160 or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as an external device 172. As described in more detail below, these communications may be facilitated using a wired or wireless connection, such as via a network 174. In general, external device 172 may be any suitable device separate from refrigerator appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with refrigerator appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control refrigerator appliance 100, etc. In addition, external device 172 and remote server 176 may communicate with refrigerator appliance 100 to communicate similar information. According to exemplary embodiments, remote server 176 may be configured to receive and analyze images obtained by camera assembly 160, e.g., to facilitate inventory analysis.

In general, communication between refrigerator appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction and configuration of refrigerator appliance 100 and camera assembly 160 have been presented according to an exemplary embodiment of the present subject matter, an exemplary method 200 for operating a camera assembly 160 is provided. Method 200 can be used to operate camera assembly 160, or to operate any other suitable camera assembly for monitoring appliance operation or inventory. In this regard, for example, controller 156 may be configured for implementing method 200. However, it should be appreciated that the exemplary method 200 is discussed herein only to describe exemplary aspects of the present subject matter and is not intended to be limiting.

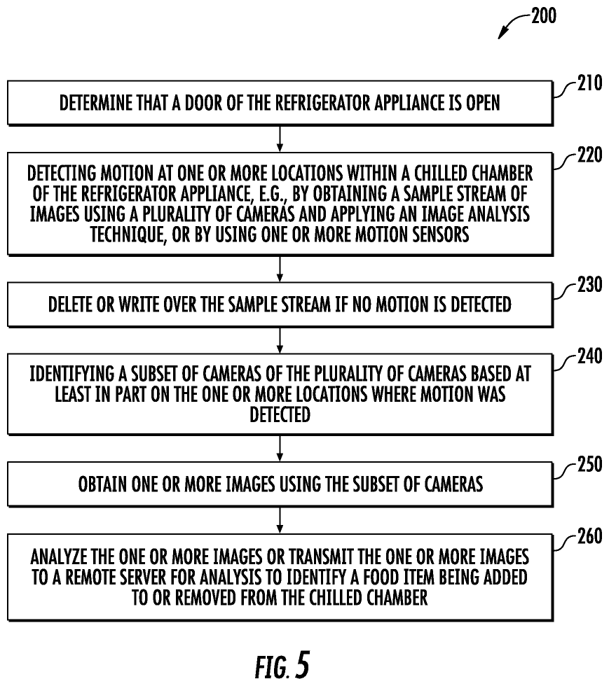

As shown in FIG. 5, method 200 includes, at step 210, determining that a door of the refrigerator appliance is open. In this regard, refrigerator appliance 100 may include one or more door switches or other systems for indicating when each door 128 is in the open position or the closed position. Notably, to conserve energy, cameras 162 may all be disabled when the doors 128 are closed. In addition, the camera 162 status may vary based on which door 128 is open. For example, if the left door 128 is opened, controller 156 may enable the cameras 162 on the left side of fresh food chamber 122 while the other cameras 162 remain disabled, and vice versa.

Step 220 may include detecting motion at one or more locations within a chilled chamber of a refrigerator appliance. For example, continuing the example from above, controller 156 of refrigerator appliance may be configured for detecting when motion occurs and identifying the location of such motion, e.g., using camera assembly 160 and/or motion sensors 166. Although exemplary methods of detecting such motion are described herein, it should be appreciated that variations and modifications may be made to these methods while remaining within the scope of the present subject matter.

For example, as described briefly above, motion sensors 166 may form a location grid for identifying the location of any motion within fresh food chamber 122, e.g., such as motion associated with a user inserting or removing a food item 164. By contrast, step 220 of detecting motion at one or more locations within the chilled chamber may include obtaining a sample stream of images using camera assembly 166 and analyzing those images using any suitable image analysis technique to identify motion and its location. In this regard, the sample stream may include one or more images (which may be low resolution images) that may be temporarily stored primarily for the purpose of detecting motion.

In this regard, for example, the sample stream obtained from each camera 162 may be one or more images or a video stream obtained at a lower resolution and standard. For example, each camera 162 may have a low resolution setting (e.g., less than 100 pixels per inch) and a high resolution setting (e.g., greater than 100 pixels per inch). In order to conserve energy when trying to detect motion, each camera 162 and camera assembly 160 may obtain the sample stream and the low resolution setting and high resolution images may be obtained only by cameras 162 oriented toward regions where motion is detected. According still other embodiments, the sample stream of images may include obtaining full resolution images and only analyzing or transmitting those images where motion is detected. Moreover, as shown for example, at step 230, sample stream images (whether high or low resolution) may be deleted or written over after use or if no motion is detected to conserve memory and computational resources.

Thus, according to exemplary embodiments, motion can be assessed directly on the controller board of each camera 162 or on a central control computer (e.g., controller 156) in the appliance that may be connected to the controller boards of all cameras 162 all camera boards. A memory buffer can be employed such that each camera is sampling into memory whenever the door is open, but only frames corresponding to motion are saved when the door is closed. It should be appreciated that the camera activation, sensor activation, and the image analysis may be dependent on the specific door open (e.g., such that only the left cameras are rolling when the left doors open with right door is closed).

Step 240 may include identifying a subset of cameras of the plurality of cameras based at least in part on the one or more locations where motion was detected. At step 250 may include obtaining one or more images using the subset of cameras. In this regard, the camera 162 or cameras 162 best positioned and oriented for monitoring the motion into or out of fresh food chamber 122 may be enabled and activated to obtain images. According to exemplary embodiments, these images are full resolution images that may facilitate improved image analysis. Notably, in this manner, full resolution image capture of the motion may be obtained while avoiding the constant monitoring by all cameras 162 of camera assembly 160. In this regard, continuing the example from above, camera assembly 160 may take one or more images, which may include one or more still images, a sample stream, one or more video clips, or any other suitable type and number of images suitable for identification of motion within fresh food chamber 122. According to exemplary embodiments, the one or more images may be obtained continuously or periodically while refrigerator doors 128 are open. Notably, the motion of the food items between raw image frames may be used to determine whether the food item 164 is being removed from or added into fresh food chamber 122. It should be appreciated that the images obtained by camera assembly 160 may vary in number, frequency, angle, resolution, detail, etc. in order to improve the clarity of food items 164.

Step 260 may include analyzing the one or more images or transmitting the one or more images to a remote server for analysis. For example, according to exemplary embodiments such analysis is intended to facilitate inventory management. As such, the image analysis may be used to identify a food item being added to or removed from the chilled chamber.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor a moving object within fresh food chamber 122. It should be appreciated that this image analysis or processing may be performed locally (e.g., by controller 156) or remotely (e.g., by offloading image data to a remote server or network, e.g., remote server 176).

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image. In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 134 based on one or more captured images from one or more cameras). Other image processing techniques are possible and within the scope of the present subject matter.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

FIG. 5 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using camera assembly 160 as an example, it should be appreciated that these methods may be applied to the operation of any suitable appliance and/or camera assembly.

As explained above, aspects of the present subject matter are generally directed to a multi-camera system of monitoring a refrigerator appliance, e.g., for inventory analysis and recording. Specifically, the multi-camera system may intelligently determine what cameras to enable contemporaneously as a user interacts with the refrigerator appliance. This determination may be made based on motion detection sensed using one or more motion sensors or by analyzing a mini stream of image or video data. Based on the regions of a chamber where motion is detected, corresponding cameras in the system may be enabled to obtain full resolution images. In this manner, data storage and transmission costs may be reduced and appliance hardware may likewise be downsized. Thus, for example, if the multi-camera system includes five cameras, but only two are required to identify objects being inserted into or removed from the refrigerator, operating only those two cameras (as opposed to all five cameras) may significantly reduce power consumption, data storage, transmission costs, computational resources, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A refrigerator appliance comprising:
a cabinet defining a chilled chamber and an opening for accessing the chilled chamber;
a door being rotatably hinged to the cabinet to provide selective access to the chilled chamber;
a plurality of cameras mounted to the cabinet for monitoring the chilled chamber, the plurality of cameras being positioned within a plane corresponding to the opening to the chilled chamber; and
a controller operably coupled to the plurality of cameras, the controller being configured to:
detect motion at one or more locations within the chilled chamber;
identify a subset of cameras of the plurality of cameras based at least in part on the one or more locations where motion was detected; and
obtain one or more images using the subset of cameras.

2. The refrigerator appliance of claim 1, wherein detecting motion at the one or more locations within the chilled chamber comprises:
obtaining a sample stream using each camera of the plurality of cameras, wherein the sample stream comprises images having a lower resolution than the one or more images obtained by the subset of cameras.

3. The refrigerator appliance of claim 2, wherein detecting motion at the one or more locations within the chilled chamber comprises:
using an image processing technique or a machine learning image recognition process to detect motion using the sample stream from each of the plurality of cameras.

4. The refrigerator appliance of claim 3, wherein the image processing technique comprises detecting motion using image differentiation.

5. The refrigerator appliance of claim 3, wherein the machine learning image recognition process comprises at least one of a convolution neural network (“CNN”), a region-based convolution neural network (“R-CNN”), a deep belief network (“DBN”), or a deep neural network (“DNN”) image recognition process.

6. The refrigerator appliance of claim 2, wherein the controller is further configured to:
delete or write over the sample stream if no motion is detected.

7. The refrigerator appliance of claim 1, further comprising:
one or more motion sensors mounted to the cabinet, and wherein detecting motion at the one or more locations within the chilled chamber comprises detecting motion within the chilled chamber using the one or more motion sensors and returning the one or more locations where motion was detected.

8. The refrigerator appliance of claim 7, wherein the one or more motion sensors are spaced apart along a vertical direction and along a lateral direction to define a location grid defined for detecting motion at the one or more locations.

9. The refrigerator appliance of claim 7, wherein the one or more motion sensors comprise at least one of proximity sensors, time-of-flight sensors, infrared sensors, or optical sensors.

10. The refrigerator appliance of claim 1, wherein the plurality of cameras comprise:
one or more horizontal mount cameras positioned on a side of the cabinet and being oriented along a horizontal direction; and
one or more vertical mount cameras positioned at a top of the cabinet and being oriented downward along a vertical direction.

11. The refrigerator appliance of claim 1, wherein each of the plurality of cameras is operably coupled with a collocated motion sensor.

12. The refrigerator appliance of claim 1, wherein the controller is further configured to:
determine that the door is closed; and
disable each of the plurality of cameras.

13. The refrigerator appliance of claim 1, wherein the controller is further configured to:
determine that the door is open prior to detecting motion at the one or more locations within the chilled chamber.

14. The refrigerator appliance of claim 1, wherein the controller is further configured to:
analyze the one or more images to identify a food item being added to or removed from the chilled chamber.

15. The refrigerator appliance of claim 1, wherein the controller is further configured to:
transmit the one or more images to a remote server for analysis.

16. A method of operating a refrigerator appliance, the refrigerator appliance comprising a chilled chamber and a plurality of cameras monitoring the chilled chamber the plurality of cameras being positioned within a plane corresponding to an opening to the chilled chamber, the method comprising:
detecting motion at one or more locations within the chilled chamber;
identifying a subset of cameras of the plurality of cameras based at least in part on the one or more locations where motion was detected; and
obtaining one or more images using the subset of cameras.

17. The method of claim 16, wherein detecting motion at the one or more locations within the chilled chamber comprises:
obtaining a sample stream using each camera of the plurality of cameras, wherein the sample stream comprises images having a lower resolution than the one or more images obtained by the subset of cameras.

18. The method of claim 17, further comprising:
deleting or writing over the sample stream if no motion is detected.

19. The method of claim 16, wherein the refrigerator appliance further comprises:
one or more motion sensors mounted to a cabinet for detecting motion within the chilled chamber and returning the one or more locations where motion was detected.

20. The method of claim 16, further comprising:
analyzing the one or more images or transmitting the one or more images to a remote server for analysis.
